(19) United States
(12) Patent Application Publication
(10) Pub. No.: US 2019/0057639 A1
(43) Pub. Date: Feb. 21, 2019

(54) DISPLAY DEVICE AND DRIVING METHOD THEREOF

(71) Applicant: Shenzhen China Star Optoelectronics Semiconductor Display Technology Co., Ltd., Shenzhen, Guangdong (CN)

(72) Inventors: Ching-hong LAI, Shenzhen, Guangdong (CN); ShenSian SYU, Shenzhen, Guangdong (CN)

(73) Assignee: Shenzhen China Star Optoelectronics Semiconductor Display Technology Co., Ltd., Shenzhen, Guangdong (CN)

(21) Appl. No.: 15/750,183

(22) PCT Filed: Sep. 6, 2017
(86) PCT No.: PCT/CN2017/100707

§ 371 Date: Feb. 3, 2018

(30) Foreign Application Priority Data
Aug. 17, 2017 (CN) 201710707953.5

(51) Int. Cl. G09G 3/22; G09G 3/20

(52) U.S. Cl. CPC G09G 3/22; G09G 2310/0264; G09G 3/2003

(57) ABSTRACT

A display device and a driving method are provided, which includes a plurality of main control modules coupled in order, a display driving module and a panel. The main control module includes a first input module, an auxiliary module and a first output module. The first input module captures images, and the first output module outputs data transmitted from the first input module and the auxiliary module to the display driving module. The display driving module includes a first calculator, and the panel displays the images processed by the first calculator. The auxiliary module is configured to provide auxiliary calculating parameters for the first calculator. By the display device and the driving method disclosed, the computation of the display driving module is reduced and the performance balance and computing efficiency are increased, so as to decrease manufacturing cost or producing obstruction and greatly raise the flexibility.

### RELATED APPLICATIONS

The present application is a National Phase of International Application Number PCT/CN2017/100707, filed Sep. 6, 2017, and claims the priority of China Application No. 201710707953.5, filed Aug. 17, 2017.

### BACKGROUND OF THE INVENTION

### 1. Field of the Invention

The disclosure relates to a signal transmission technical field, and more particularly to a display device and a driving method thereof.

### BACKGROUND

In recent years, share of the high-resolution panel with respect to the terminal device market is gradually increased. However, while the high-resolution panel is gradually increasing, corresponding computation loading and complexity are also increased. The computation loading and complexity are increased, which leads to raise manufacturing cost or more difficultly producing of the panel driving module, even performance balance and computing efficiency of the display panel are reduced. Thus, the flexibility of the panel driving module is greatly decreased.

### SUMMARY

For solving the problem of current technology, a display device and a driving method thereof are provided by this disclosure, which can efficiently decrease manufacturing cost or producing obstruction and greatly raise the flexibility of display driving module.

An objective of the disclosure is achieved by following embodiments.

In an embodiment, a display device includes a plurality of main control modules coupled in order, a display driving module and a panel. The main control module includes a first input module, an auxiliary module and a first output module. The first input module is configured to capture images, and the first output module is configured to output data transmitted from the first input module and the auxiliary module to the display driving module. The display driving module includes a first calculator. The panel is configured to display the images processed by the first calculator. The auxiliary module is configured to provide auxiliary calculating parameters for the first calculator.

In an embodiment, the data outputted from the first output module is transmitted to the display driving module by utilizing a low voltage differential signal as a data packet.

In an embodiment, the main control module further includes a marking module, and the display driving module further includes an identifying module and storage. The auxiliary calculating parameters are transmitted to the first calculator after transformed to marks in respect with vacant field of the data packet formed by the low voltage differential signal. The storage stores the marks and a mapping table corresponding to the marks, the identifying module decodes the marks utilized by the first calculator the according to the mapping table.

In an embodiment, the data packet formed by the low voltage differential signal includes at least one data pair configured to be flag bits corresponding to the auxiliary calculating parameters.

In an embodiment, the auxiliary calculating parameter includes location/coverage and/or color of characteristic patterns, and the first calculator is configured to adjust the color characteristic with respect to specific location/coverage of the characteristic patterns.

In an embodiment, the auxiliary module includes a second calculator, the auxiliary calculating parameters are generated by the auxiliary module according to the algorithm processing, and then the first calculator finishes leftover calculation in accordance with the auxiliary calculating parameters.

In an embodiment, a driving method for display device includes following steps. A plurality of data packets formed by a low voltage differential signal is obtained, wherein the data packet includes data in respect with images and auxiliary calculating parameters. The auxiliary calculating parameters are transformed by a main control module to marks in respect with vacant field of the data packets formed by the low voltage differential signal. The marks are decoded by a display driving module according to a mapping table in accordance with the marks and the mapping table corresponding to the marks of the data packets. The leftover calculation is calculated by a first calculator of the display driving module in accordance with the auxiliary calculating parameters decoded to process and output the images. The images are displayed by a panel according to data of the images outputted from the display driving module.

In an embodiment, the data packet formed by the low voltage differential signal includes at least one data pair configured to be flag bits corresponding to the auxiliary calculating parameters.

In an embodiment, the auxiliary calculating parameter includes location/coverage and/or color of characteristic patterns, and the first calculator is configured to adjust the color characteristic with respect to specific location/coverage of the characteristic patterns.

In an embodiment, the auxiliary module includes a second calculator, the auxiliary calculating parameters are generated by the auxiliary module according to the algorithm processing, and then the first calculator finishes leftover calculation in accordance with the auxiliary calculating parameters.

While the display driving module outputs image data to the panel, the whole or partial transmission of characteristic data in respective with image parameters or calculation is achieved by the main control module. Thus, the computation of the display driving module is reduced and the performance balance and computing efficiency are increased, so as to decrease manufacturing cost or producing obstruction and greatly raise the flexibility.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic of a display device according to an embodiment of the disclosure;

FIG. 2a is a structural schematic of mark location in respect with first type vacant field of data packet according to the embodiment of the disclosure;

FIG. 2b is a schematic of mark location in respect with second type vacant field of the data packet according to the embodiment of the disclosure;

FIG. 2c is a schematic of mark location in respect with third type vacant field of the data packet according to the embodiment of the disclosure;

FIG. 2d is a schematic of mark location in respect with fourth type vacant field of the data packet according to the embodiment of the disclosure;

FIG. 3 is a schematic of marking method of images according to the embodiment of the disclosure; and

FIG. 4 is a schematic of driving method of the display device according to an embodiment of the disclosure.

### DETAILED DESCRIPTION OF THE PREFERRED EMBODIMENTS

In order to understand the above objectives, features and advantages of the present disclosure more clearly, the present disclosure is described in detail below with references to the accompanying drawings and specific embodiments.

A display device disclosed by this disclosure includes a plurality of main control modules coupled in order, a display driving module and a panel. The main control module includes a first input module, an auxiliary module and a first output module. The first input module can be realized by, for example, each of input ports, and is configured to obtain images by receiving or loading, etc. The setting module is configured to generate operating parameters of the display driving module. The first output module can be realized by, for example, each of output ports, and is configured to transmit data outputted from the first input module, the setting module and the auxiliary module to the display driving module. The display driving module includes a first calculator. The panel is configured to display the images processed by the first calculator. The auxiliary module is configured to provide auxiliary calculating parameters for the first calculator.

The main module receives or loads the images by each of input ports, and simultaneously transmits the images to the display driving module by ports after sets necessary configuration for the display driving module by setting ports of the display driving module. Then, the auxiliary operating parameters provided by the auxiliary module are calculated with the algorithm processing utilized by the first calculator. Finally, the images are displayed on the panel after finishing leftover calculation, and to avoid that whole calculation is depended on the display driving module, so as to decrease manufacturing cost or producing obstruction and greatly raise the flexibility.

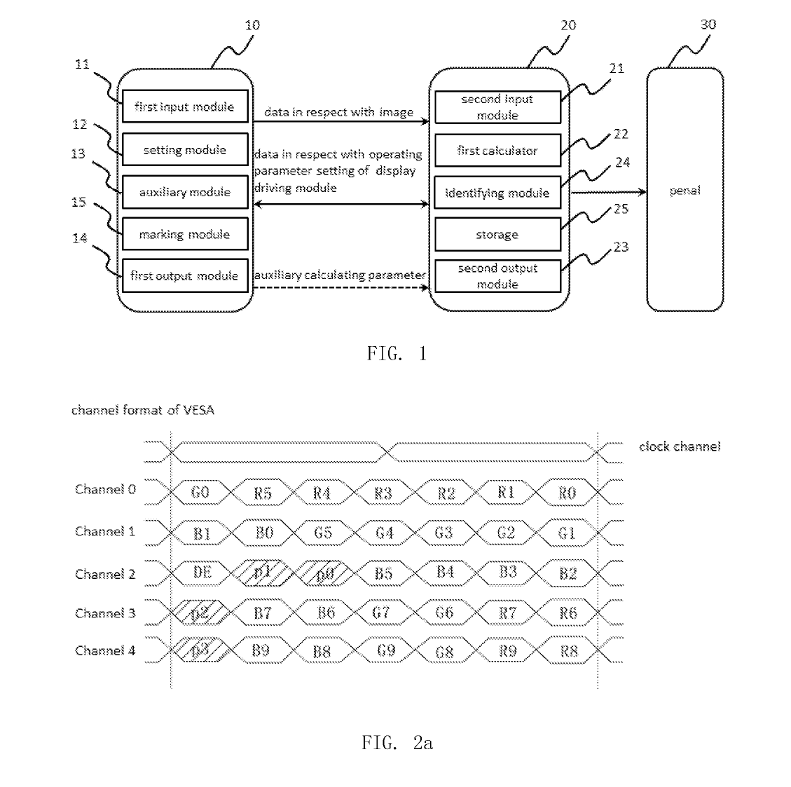

Reference is made to FIG. 1. A display device includes a plurality of main control modules 10 coupled in order, a display driving module 20 and a panel 30. The main control module 10 includes a first input module 11, an auxiliary module 12, a setting module 13 and a first output module 14. The first input module 11 is configured to capture images, and the first output module 14 is configured to output data transmitted from the first input module 11 and the auxiliary module 12 to the display driving module 20. The display driving module 20 includes a second input module, a first calculator 22, and a second output module 23. The panel 30 is configured to display the images processed by the first calculator 22. The auxiliary module 13 is configured to provide auxiliary calculating parameters for the first calculator 22.

That is, the first output module 14 is configured to output data in respect with images, the display driving module's operating parameters, and auxiliary operating parameters. The data is transmitted through the first output module 14, second input module 21 to the first calculator 22. The first calculator 22 processes corresponding algorithm processing for the images based on the auxiliary operating parameters provided by the auxiliary module 13. After processing, the images are displayed on the panel 30 via the second output module 23.

In this embodiment, the data outputted from the first output module 14 is transmitted to the display driving module by utilizing a low voltage differential signal (LVDS) as a data packet. The main control module 10 further includes marking module 15, and the display driving module 20 further includes an identifying module 24 and storage 25. The auxiliary calculating parameters are transmitted to the first calculator 22 after transformed to marks in respect with vacant field of the data packet formed by the low voltage differential signal. The storage 25 stores the marks and a mapping table corresponding to the marks, and the identifying module 24 decodes the marks utilized by the first calculator 22 the according to the mapping table.

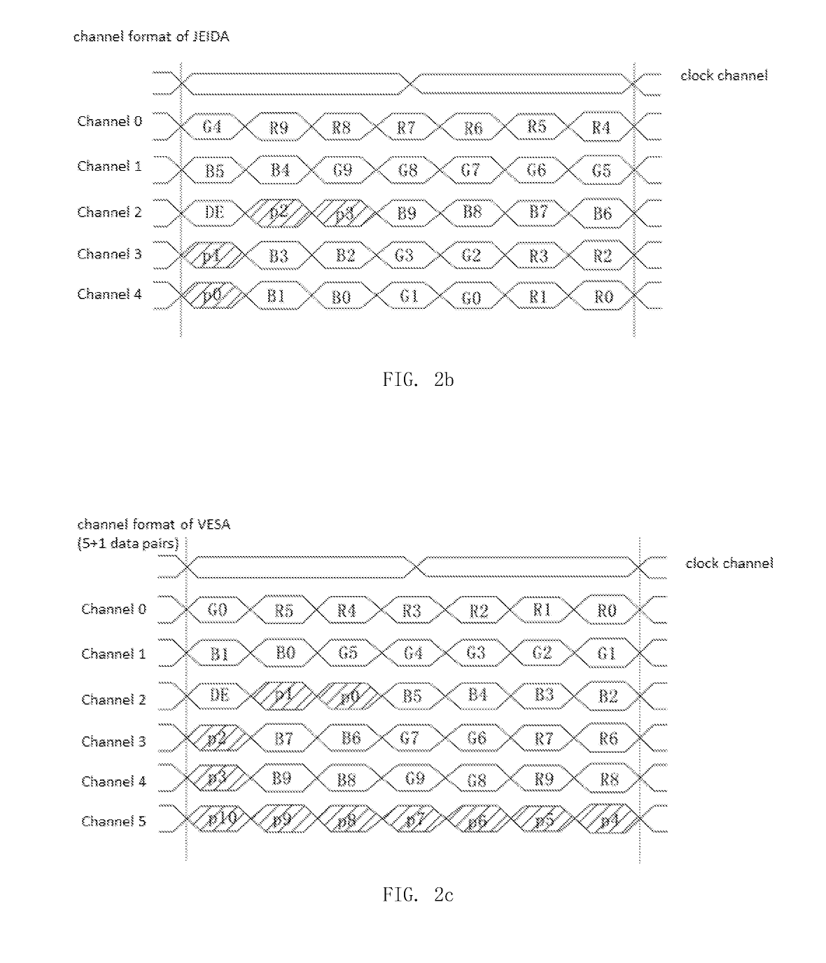

Reference is made to FIG. 2a, which is a structural schematic of mark location in respect with first type vacant field of data packet according to the embodiment of the disclosure. While under transmitting by three data pairs (corresponding channel 0, channel 1, channel 2), the data packet of the LVDS is able to transmit 21-bits data for each clock period, and each data packet includes each 6-bits image data for RGB, 1-bit DE data, 1-bit VS data, and 1-bit HS data. The DE means “data enable”, VS means “vertical synchronization”, and HS means “Horizontal synchronization”. The valid data pairs are R0-R5, G0-G5, B0-B5, and locations of marks p0, p1 are 2-bits vacant field of the data packet corresponded to the VS data and HS data. While under transmitting by four data pairs (corresponding channel 0, channel 1, channel 2, channel 3), the data packet of the LVDS is able to transmit 28-bits data for each clock period, and each data packet includes each 8-bits RGB image data for each channel, 1-bit DE data, 1-bit VS data, 1-bit HS data, and 1-bit vacant data. The valid data pairs are R0-R7, G0-G7, B0-B7, and locations of marks p0, p1, and p2 are 3-bits vacant field of the data packet corresponded to the VS data, HS data, and vacant data. While under transmitting by five data pairs, the valid data pairs are R0-R9, G0-G9, B0-B9, and locations of marks p0, p1, p2 and p3 are 3-bits vacant field of the data packet corresponded to the VS data, HS data, and 4-bits code of vacant field corresponded to the vacant data.

FIGS. 2a and 2b are schematic of location of flag bits in respect with vacant field of the DE data, the HS data, the VS data, which adjacent to the RGB image data within the LVDS data packet. Such as FIGS. 2c and 2d, the location of the flag bits disclosed in present disclosure further could be achieved by extending data. Pairs of data can be utilized as placement locations for a variety of flag bits to achieve more types of parameters in transmission.

FIG. 2c is a schematic of mark location in respect with another type vacant field of the data packet of VESA channel according to the embodiment of the disclosure. This method extends a data pair as channel 5 continuing after channel 0-4, and whole data pairs are to be the mark locations for transmitting parameters corresponding to the marks.

FIG. 2d is a schematic of mark location in respect with another type vacant field of the data packet of VESA channel according to the embodiment of the disclosure. This method extends two data pairs as channels 3 and 4 continuing after channel 0-2, and the two data pairs are to be the flag bits to insert corresponded marks for transmitting parameters corresponding to the marks.

It can be understood, number of data pairs corresponding to the flag bits in the data packet formed by the LVDS that are extended to be used as the auxiliary operating parameters is not limited and can be adjusted in accordance with practiced need.

For example, in the calculating process of the first calculator of display driving calculating module, partial algorithm needs to add effect or do cancellation on human face. However, in current output method of the panel, the display driving algorithm has to firstly input the identification information of the human face, and then to add effect or do cancellation. This embodiment provides related parameters by the main control module to let the display driving calculating module directly perform the step of adding effect or doing cancellation. At the same time, this method can avoid the problem of double counting or synergy while the main control module and the display driving calculating module operating.

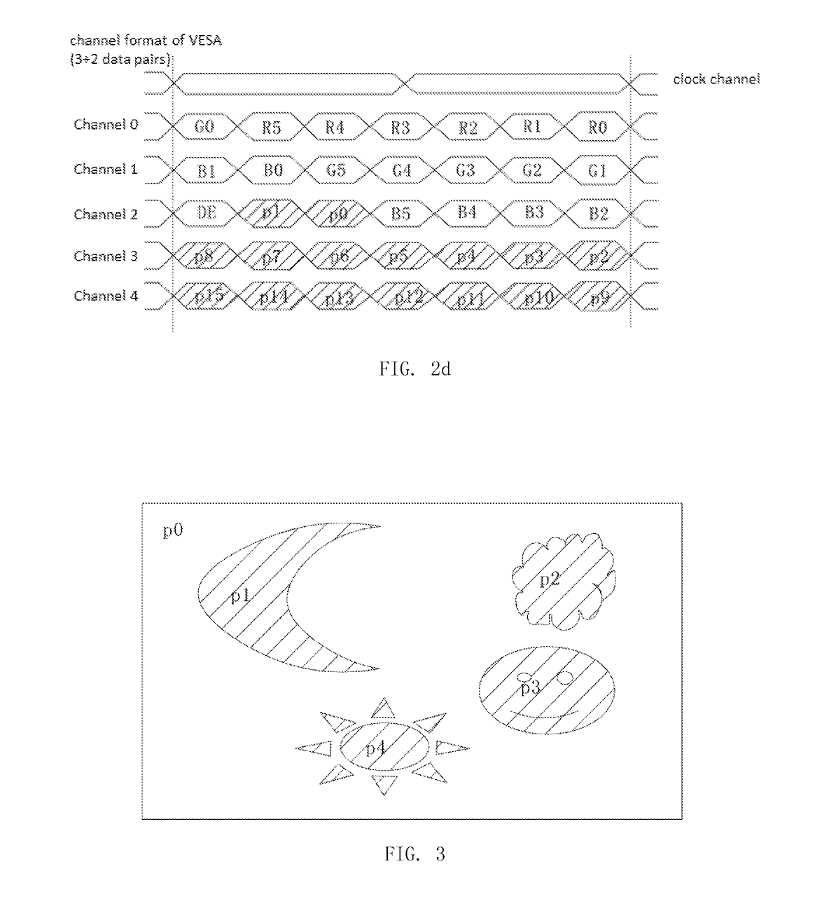

Shown as FIG. 3, which is a schematic of marking method of images according to the embodiment of the disclosure. On the side of the main control module 10, the main control module 10 loads a serious of auxiliary operating parameters from the auxiliary module 13, such as location/coverage and/or color of characteristic patterns. The display images to be displayed has following characteristic patterns: first characteristic pattern “moon”, second characteristic pattern “cloud”, third characteristic pattern “face” , fourth characteristic pattern “sun”, and other non-characteristic patterns. The location/coverage and/or color of characteristic patterns means the location/coverage and/or color of pixels corresponding to the characteristic patterns, and the color characteristic means parameters of hue, saturation, contrast or etc. After the auxiliary calculating parameters are loaded, the marking module 15 will respectively mark the specific pixels: the auxiliary calculating parameters of the first characteristic pattern, the second characteristic pattern, the third characteristic pattern, the fourth characteristic pattern, and other non-characteristic patterns are marked as p1, p2, p3, p4, and p0. In the LVDS data packet, the marks of p1, p2, p3, p4, and p0 corresponding to those auxiliary calculating parameters are respectively inserted into the flag bits, and transmitted with RGB image data by the first output module 14.

On the side of the display driving module 20, the storage 25 stores the marks p1, p2, p3, p4, and p0 and the mapping table corresponding to the marks p1, p2, p3, p4, and p0. The identifying module 24 decodes the marks p1, p2, p3, p4, and p0 within the LVDS data packet received form the second input module 21, and obtains each auxiliary calculating parameter. Then, the first calculator 22 determines whether or how to adjust the color characteristic with respect to specific location/coverage of the characteristic patterns, so as to finish leftover calculation of image processing.

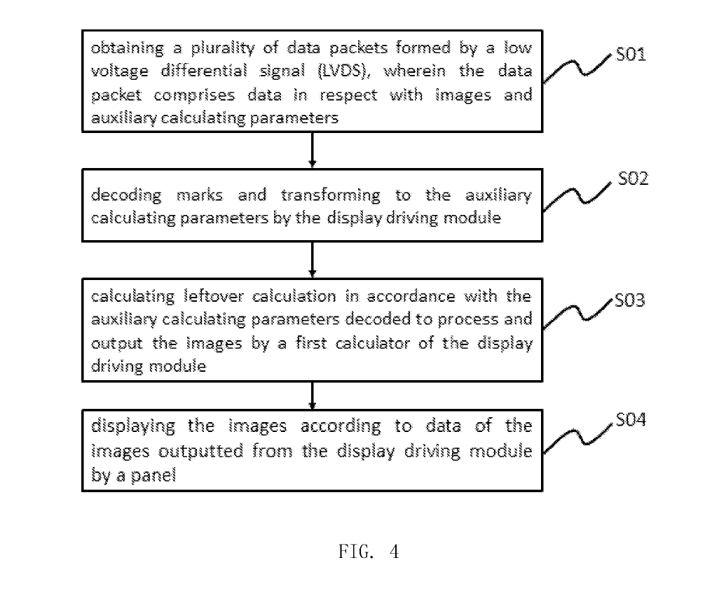

Shown as FIG. 4, this disclosure provides a driving method of the display device, includes:

S01, obtaining a plurality of data packets formed by a low voltage differential signal, wherein the data packet comprises data in respect with images and auxiliary calculating parameters; by a main control module, transforming the auxiliary calculating parameters to marks in respect with vacant field of the data packets formed by the low voltage differential signal;

S02, by a display driving module, decoding the marks the according to a mapping table in accordance with the marks and the mapping table corresponding to the marks of the data packets;

S03, by a first calculator of the display driving module, calculating leftover calculation in accordance with the auxiliary calculating parameters decoded to process and output the images; and

S04, by a panel, displaying the images according to data of the images outputted from the display driving module.

Wherein the data packet formed by the low voltage differential signal includes at least one data pair configured to be flag bits corresponding to the auxiliary calculating parameters. The auxiliary calculating parameter includes location/coverage and/or color of characteristic patterns, and the first calculator is configured to adjust the color characteristic with respect to specific location/coverage of the characteristic patterns.

In other embodiment, the auxiliary module 13 further includes a second calculating module. On the side of the main control module 10, the auxiliary module 13 generates auxiliary calculating parameters by the algorithm processing in advance to be the base data for leftover calculation. On the side of the display driving module 20, the first calculator finishes the leftover calculation in accordance with the auxiliary calculating parameters and raises whole operating preference. For example, in the digital image process, histogram equalization is necessary algorithm to be applied for the images. After the main control module 10 received the images, the second calculator thereof can finish first half part of the histogram equalization such as the number of occurrences of each gray level in respect with histogram. The first calculator continually calculates second half part of the histogram equalization based on the result outputted from the main control module 10. That is cumulative normalized histogram, and new pixel value is calculated. Thus, the operation that the display driving module performs histogram statistics can be reduced, and the computing efficiency and flexibility of the display driving module are raised.

In addition, other algorithm of high complexity part or changeable request in the future can be implemented and calculated by the second calculator. Except to effectively reducing the design complexity of the display driving module, also to provide a flexible scheme for algorithm updates.

Summary, while the display driving module outputs image data to the panel, the whole or partial transmission of characteristic data in respective with image parameters or calculation is achieved by the main control module. Thus, the computation of the display driving module is reduced and the performance balance and computing efficiency are increased, so as to decrease manufacturing cost or producing obstruction and greatly raise the flexibility.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A display device, comprising a plurality of main control modules coupled in order, a display driving module and a panel,
the main control module comprising a first input module, an auxiliary module and a first output module, the first input module configured to capture images, and the first output module configured to output data transmitted from the first input module and the auxiliary module to the display driving module;
the display driving module comprising a first calculator; the panel configured to display the images processed by the first calculator; and
the auxiliary module configured to provide auxiliary calculating parameters for the first calculator.

2. The display device according to claim 1, wherein the data outputted from the first output module is transmitted to the display driving module by utilizing a low voltage differential signal as a data packet.

3. The display panel according to claim 2, wherein the main control module further comprises a marking module, the display driving module further comprises an identifying module and a storage; the auxiliary calculating parameters are transmitted to the first calculator after transformed to marks in respect with vacant field of the data packet formed by the low voltage differential signal, the storage stores the marks and a mapping table corresponding to the marks, the identifying module decodes the marks utilized by the first calculator the according to the mapping table.

4. The display panel according to claim 3, wherein the data packet formed by the low voltage differential signal comprises at least one data pair configured to be flag bits corresponding to the auxiliary calculating parameters.

5. The display panel according to claim 1, wherein the auxiliary calculating parameter comprises location/coverage and/or color of characteristic patterns, and the first calculator is configured to adjust the color characteristic with respect to specific location/coverage of the characteristic patterns.

6. The display panel according to claim 5, wherein the auxiliary module comprises a second calculator, the auxiliary calculating parameters are generated by the auxiliary module according to the algorithm processing, and then the first calculator finishes leftover calculation in accordance with the auxiliary calculating parameters.

7. The display panel according to claim 2, wherein the auxiliary module comprises location/coverage and/or color of characteristic patterns, and the first calculator is configured to adjust the color characteristic with respect to specific location/coverage of the characteristic patterns.

8. The display panel according to claim 7, wherein the auxiliary module comprises a second calculator, the auxiliary calculating parameters are generated by the auxiliary module according to the algorithm processing, and then the first calculator finishes leftover calculation in accordance with the auxiliary calculating parameters.

9. The display panel according to claim 3, wherein the auxiliary module comprises location/coverage and/or color of characteristic patterns, and the first calculator is configured to adjust the color characteristic with respect to specific location/coverage of the characteristic patterns.

10. The display panel according to claim 9, wherein the auxiliary module comprises a second calculator, the auxiliary calculating parameters are generated by the auxiliary module according to the algorithm processing, and then the first calculator finishes leftover calculation in accordance with the auxiliary calculating parameters.

11. The display panel according to claim 4, wherein the auxiliary module comprises location/coverage and/or color of characteristic patterns, and the first calculator is configured to adjust the color characteristic with respect to specific location/coverage of the characteristic patterns.

12. The display panel according to claim 11, wherein the auxiliary module comprises a second calculator, the auxiliary calculating parameters are generated by the auxiliary module according to the algorithm processing, and then the first calculator finishes leftover calculation in accordance with the auxiliary calculating parameters.

13. A driving method for display device, comprising:
obtaining a plurality of data packets formed by a low voltage differential signal, wherein the data packet comprises data in respect with images and auxiliary calculating parameters;
by a main control module, transforming the auxiliary calculating parameters to marks in respect with vacant field of the data packets formed by the low voltage differential signal;
by a display driving module, decoding the marks the according to a mapping table in accordance with the marks and the mapping table corresponding to the marks of the data packets;
by a first calculator of the display driving module, calculating leftover calculation in accordance with the auxiliary calculating parameters decoded to process and output the images; and
by a panel, displaying the images according to data of the images outputted from the display driving module.

14. The driving method for display device according to claim 13, wherein the auxiliary calculating parameters are generated according to the algorithm processing in the main control module, the first calculator finishes leftover calculation in accordance with the auxiliary calculating parameters in the display driving module.

15. The driving method for display device according to claim 13, the data packet formed by the low voltage differential signal comprises at least one data pair configured to be flag bits corresponding to the auxiliary calculating parameters,

16. The driving method for display device according to claim 15, wherein the auxiliary calculating parameters are generated according to the algorithm processing in the main control module, the first calculator finishes leftover calculation in accordance with the auxiliary calculating parameters in the display driving module.

17. The driving method for display device according to claim 13, the auxiliary calculating parameter comprises location/coverage and/or color of characteristic patterns, and the first calculator is configured to adjust the color characteristic with respect to specific location/coverage of the characteristic patterns.

18. The driving method for display device according to claim 17, wherein the auxiliary calculating parameters are generated according to the algorithm processing in the main control module, the first calculator finishes leftover calculation in accordance with the auxiliary calculating parameters in the display driving module.

19. A driving method for display device, comprising:
capturing a plurality of data packets formed by a low voltage differential signal, wherein the data packet comprises data in respect with images and auxiliary calculating parameters;
by a main control module, transforming the auxiliary calculating parameters to marks in respect with vacant field of the data packets formed by the low voltage differential signal;
by a display driving module, decoding the marks the according to a mapping table in accordance with the marks and the mapping table corresponding to the marks of the data packets;
by a first calculator of the display driving module, finishes leftover calculation in accordance with the auxiliary calculating parameters decoded to process and output the images; and
by a panel, displaying the images according to data of the images outputted from the display driving module,
wherein the channel format of the data packets formed by a low voltage differential signal is standard of VESA (Video Electronics Standards Association) or JEIDA (Japanese Electronic Industry Development Association).

20. The driving method for display device according to claim 19, the data packet formed by the low voltage differential signal comprises at least one data pair configured to be flag bits corresponding to the auxiliary calculating parameters; the auxiliary calculating parameters are generated according to the algorithm processing in the main control module, the first calculator finishes leftover calculation in accordance with the auxiliary calculating parameters in the display driving module.
